(19) United States
(12) Patent Application Publication
(10) Pub. No.: US 2026/0139177 A1
(43) Pub. Date: May 21, 2026

(54) AZEOTROPIC AND NON-AZEOTROPIC HYDROFLUORO OLEFIN FORMULATIONS FOR CRYOGENIC HEAT TRANSFER

(71) Applicant: Illinois Tool Works Inc., Glenview, IL (US)

(72) Inventors: Paul M. Blair, Jonesboro, GA (US); Zhihong Ye, Kennesaw, GA (US); Alexander A. Dressel, Kennesaw, GA (US)

(21) Appl. No.: 19/377,207

(22) Filed: Nov. 3, 2025

Related U.S. Application Data
(60) Provisional application No. 63/722,446, filed on Nov. 19, 2024.

(51) Int. Cl. C09K 5/04; C09K 5/10

(52) U.S. Cl. CPC C09K 5/044; C09K 5/10; C09K 2205/126

(57) ABSTRACT

The present disclosure relates generally to azeotropic and non-azeotropic hydrofluoro olefin formulations, particularly formulations including cis-1-Chloro-3,3,3-trifluoropropene, also known as HFO-1233zd(Z), for cryogenic heat transfer.

### CROSS-REFERENCE TO RELATED APPLICATIONS

This application claims the benefit of priority to U.S. provisional patent application No. 63/722,446 entitled “Azeotropic and Non-Azeotropic Hydrofluoro Olefin Formulations for cryogenic heat transfer”, filed Nov. 19, 2024, the contents of which are herein incorporated by reference in their entirety.

### FIELD

The present disclosure relates generally to azeotropic and non-azeotropic hydrofluoro olefin formulations, particularly formulations including cis-1-Chloro-3,3,3-trifluoropropene, also known as HFO-1233zd(Z), for cryogenic heat transfer.

### BACKGROUND

A heat transfer fluid is a liquid (or gas) that transfers heat between relatively high temperature and relatively low temperature sources and sinks to provide temperature control. Semiconductor manufacturers use heat transfer fluids in both cooling and heating applications, including to control temperature during manufacturing and to testing semiconductor chips within finished electronic products.

1-Chloro-3,3,3-trifluoropropene (HFO-1233zd) is an unsaturated chlorofluorocarbon that has the chemical formula HClC═C(H)CF₃. HFO-1233zd exists as Z- (cis-) and E- (trans-) isomers. The trans-isomer, HFO-1233zd(E), has become of some interest as a more environmentally friendly refrigerant, since it has a lower global warming potential or GWP than certain existing refrigerants. Both HFO-1233zd isomers may be prepared by fluorination and dehydrohalogenation reactions starting with 1,1,1,3,3-pentachloropropane.

While there has been some interest in HFO-1233zd(E) as a more environmentally friendly refrigerant, formulations containing HFO-1233zd(Z) may also have potential, and are explored in the present disclosure. As such, there exists a need for a heat transfer fluid comprising HFO-1233zd(Z).

### SUMMARY

According to an aspect of the present disclosure, a cryogenic heat transfer fluid may comprise cis-1-Chloro-3,3,3-trifluoropropene. According to another aspect of the present disclosure, a cryogenic heat transfer fluid may consist of cis-1-Chloro-3,3,3-trifluoropropene. The cryogenic heat transfer fluid may be used at temperatures between −100 and 30° C., or between −100 and −35°C.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

The following is a description of the examples depicted in the accompanying drawings. The figures are not necessarily to scale, and certain features and certain views of the figures may be exaggerated in scale or in schematic for clarity or conciseness.

FIG. 1 illustrates a skeletal structural formula of cis-1-Chloro-3,3,3-trifluoropropene, also known as HFO-1233zd(Z).

FIG. 2 illustrates a skeletal structural formula of trans-1-Chloro-3,3,3-trifluoropropene, also known as HFO-1233zd(E).

The foregoing summary, as well as the following detailed description, will be better understood when read in conjunction with the figures. It should be understood that the claims are not limited to the arrangements and instrumentality shown in the figures. Furthermore, the appearance shown in the figures is one of many ornamental appearances that can be employed to achieve the stated functions of the apparatus.

### DETAILED DESCRIPTION

In the following detailed description, specific details may be set forth to provide a thorough understanding of the embodiments of the present disclosure. However, it will be clear to one skilled in the art when disclosed examples may be practiced without some or all of these specific details. For the sake of brevity, well-known features or processes may not be described in detail. In addition, like or identical reference numerals may be used to identify common or similar elements.

One or more specific embodiments of the present disclosure will be described below. In an effort to provide a concise description of these embodiments, all features with an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

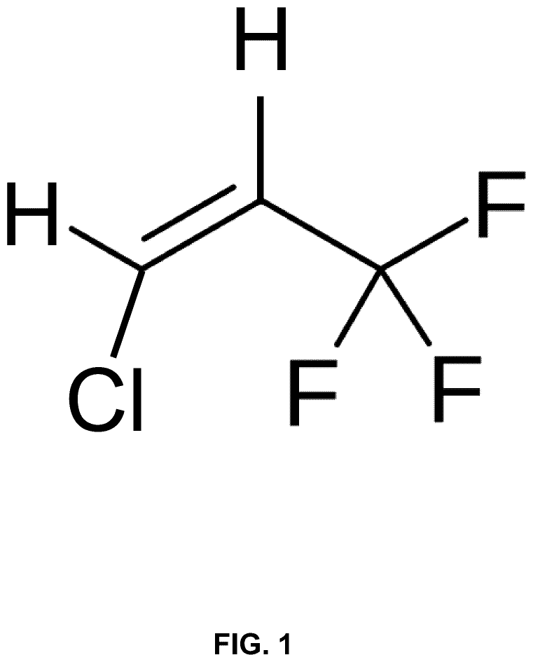

FIG. 1 illustrates a skeletal structural formula of cis-1-Chloro-3,3,3-trifluoropropene, also known as HFO-1233zd(Z). HFO-1233zd(Z) may be used as a cryogenic heat transfer fluid. In some embodiments according to the current disclosure, the cryogenic heat transfer fluid may consist of HFO-1233zd(Z). In other embodiments, the cryogenic heat transfer fluid may also contain trans-1,2-dichloroethylene, low molecular weight alcohols such as methanol, low molecular weight hydrocarbons, and cyclic hydrocarbons.

Generally speaking, a refrigerant is a working fluid used in cooling, heating or reverse cooling and heating of air conditioning systems and heat pumps where they undergo a repeated phase transition from a liquid to a gas (expansion where heat is absorbed into the refrigerant from the surroundings) and gas to a liquid (compression where the gas is compressed into liquid so it becomes hotter than its surrounding and thereby transfers heat to the surroundings).

As used in the present disclosure, a “heat transfer fluid” does not rely on mechanical compression to return to liquid state.

In a single-phase system, heat is absorbed into a heat transfer fluid from a heat source primarily by conduction and convection. The heat transfer fluid is then transported as a fluid to a cooler heat sink where the heat is transferred mostly by conduction and convection.

In a two-phase system, heat is absorbed into a heat transfer fluid from a heat source primarily by phase change such as boiling (from liquid to vapor), conduction and convection. The heat transfer fluid is then transported as a fluid to a cooler heat sink where the heat is transferred mostly by condensation (from vapor to liquid), conduction and convection. No mechanical compression is used to return the heat transfer fluid to liquid state.

In some embodiments according to the current disclosure, a method of cryogenic heat transfer may involve using a cryogenic heat transfer fluid comprising cis-1-Chloro-3,3,3-trifluoropropene at temperatures between −101 and 39° C. (the melting and boiling points, respectively, of cis- 1-Chloro-3,3,3-trifluoropropene), between −100 and 30° C., between −100 and −35° C., or between −80° C. and −50° C. For example, a cryogenic heat transfer fluid comprising HFO-1233zd(Z) may be used to cool manufactured parts used for a cryogenic application or procedure down to between −90° C. and −60° C., or between −70° C. and −80° C. Such an application or procedure likely require a cryogenic heat transfer fluid with a freezing point at or below −100° C.—at least below the temperature at which the application or procedure is being conducted. By way of another example, a cryogenic heat transfer fluid comprising HFO-1233zd(Z) may be used to transfer heat from processing equipment to a chiller and back to the processing equipment. Such an application may requires operation at between −70° C. and −60° C., or at −65° C., and as a result requires a cryogenic heat transfer fluid with a freezing point at or below −75° C.

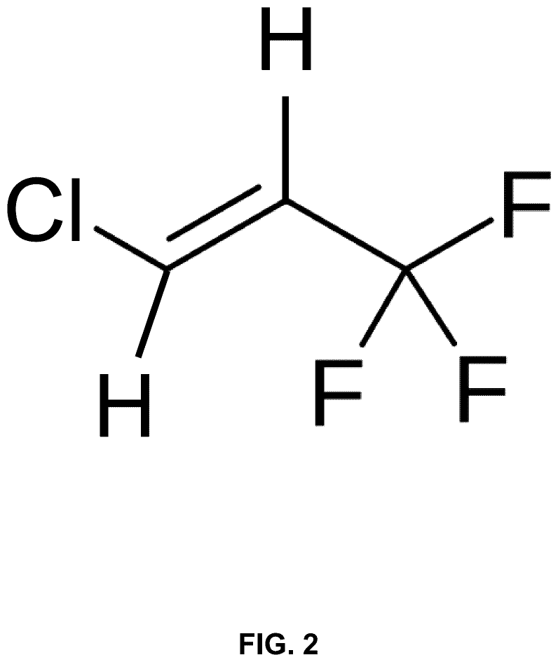

FIG. 2 illustrates a skeletal structural formula of trans-1-Chloro-3,3,3-trifluoropropene, also known as HFO-1233zd(E). HFO1233zd(E) is the trans isomer of HFO1233zd. Even though HFO1233zd(E) could operate in a temperature range of between −100 and −35° C., it is highly volatile and its boiling point is 19° C. (66° F.) which can make HFO1233zd(E) difficult to handle at typical ambient temperatures.

The various aspects and embodiments disclosed herein are not intended to be limiting. Other embodiments may be utilized, and other changes may be made, without departing from the spirit or scope of the subject matter presented herein. It will be readily understood that the aspects of the present disclosure, as generally described herein and illustrated in the figures, can be arranged, substituted, combined, separated, and designed in a wide variety of different configurations, all of which are contemplated herein.

1. A cryogenic heat transfer fluid comprising cis-1-Chloro-3,3,3-trifluoropropene.

2. A cryogenic heat transfer fluid consisting of cis-1-Chloro-3,3,3-trifluoropropene.

3. A method of using the cryogenic heat transfer fluid of claim 1 between temperatures of −101 and 39 °C.

4. A method of using the cryogenic heat transfer fluid of claim 3 between temperatures of −100 and 30 °C.

5. A method of using the cryogenic heat transfer fluid of claim 4 between temperatures of −100 and −35 °C.

6. A method of using the cryogenic heat transfer fluid of claim 5 between temperatures of −80 and −50 °C.

7. A method of using the cryogenic heat transfer fluid of claim 1 in a single-phase system involving the steps of:
a. generating heat at a heat source;
b. transporting a heat transfer fluid towards the heat source;
c. transferring heat from the heat source to the heat transfer fluid primarily by conduction and convection;
d. transporting the heat transfer fluid to a cooler heat sink; and
e. transferring heat from the heat transfer fluid to the cooler heat sink primarily by conduction and convection.

8. A method of using the cryogenic heat transfer fluid of claim 1 in a two-phase system involving the steps of:
a. generating heat at a heat source;
b. transporting a heat transfer fluid towards the heat source;
c. transferring heat from the heat source to the heat transfer fluid primarily by boiling, conduction and convection;
d. transporting the heat transfer fluid to a cooler heat sink; and
e. transferring heat from the heat transfer fluid to the cooler heat sink primarily by condensation, conduction and convection.
